(19) United States
(12) Patent Application Publication
(10) Pub. No.: US 2020/0216988 A1
(43) Pub. Date: Jul. 9, 2020

(54) ADDITIVE MANUFACTURING-3D PRINTING OF THREE-DIMENSIONAL WOVEN STRUCTURES

(71) Applicant: Derck VAN SCHUYLENBURCH, Truth or Consequences, NM (US)

(72) Inventor: Derck VAN SCHUYLENBURCH, Truth or Consequences, NM (US)

(21) Appl. No.: 16/632,986

(22) PCT Filed: Jul. 24, 2018
(86) PCT No.: PCT/US2018/043439

§ 371 Date: Jan. 22, 2020

Related U.S. Application Data
(60) Provisional application No. 62/536,766, filed on Jul. 25, 2017.

(51) Int. Cl. D03D 25/00; B33Y 80/00

(52) U.S. Cl. CPC D03D 25/005; B33Y 80/00

(57) ABSTRACT

An interwoven structure is provided. The interwoven structure includes a plurality of adjacent sets of lateral elements comprised of a substantially non-flexible material extruded from a 3-D printer; a plurality of adjacent sets of transverse elements comprised of a material extruded from a 3-D printer and a plurality of adjacent sets of vertical elements comprised of a material extruded from a 3-D printer. The lateral, transverse, and vertical sets of elements are substantially mutually perpendicular to one coupled at a plurality of intersection nodes. The lateral, transverse and vertical sets of elements form an isotopically interwoven 3-dimensional weavement.

### FIELD OF THE INVENTION

The present disclosure relates generally to the geometrical configuration of three-dimensional woven structures, and more particularly to three-dimensional woven structures created using additive manufacturing.

### DESCRIPTION OF THE PRIOR ART

A wide variety of reinforced fiber or filament composite materials and structures are known in the art. Such structures may consist of an array of fibers, filaments or rods embedded in a matrix-material, which encases the fibers and fixes them into position. Any number of materials, including but not limited to glass, quartz, graphite, steel, asbestos and boron, may be used as fibers or filaments in such composite materials. Similarly, many materials, including plastics, ceramics and resins, to name just a few, may form the matrix-material.

However, attempting to interweave various fibers or rods to a high degree of interweavement, to be fully interwoven with one another, can be challenging. Some materials may require significant manipulation in order to weave together. Additionally or alternatively, some materials may, before interweavement, be fragile or weak and would be subject to cracks, breaks, frays, or any other damage during weaving that could result in a weakening of the overall structure. Additionally or alternatively, interweavement of various materials can take significant time and effort to make.

An additional problem that can result from prior art structures is when using hollow fibers or rods, even if the fibers or rods are not damaged upon weaving, the resulting structure could have points of structural weakness. Conversely, when using fibers or rods that are solid or dense, the resulting structure could be very heavy.

Recently, 3D-printing or additive manufacturing has emerged on the scene and presented itself as an alternative manufacturing method for the manufacture of a host of different items. It has allowed the assembly of multiple parts to be 3D-printed as one part, complete with internal passageways, etc. In one example, 3D-printing has been used in aerospace applications to create superior parts for advanced jet engines and the like.

When some items are produced using a 3D printer or the additive manufacturing method, the item may be rendered less useful or possibly useless for its prior or known application(s). However, such items may have acquired one or more different or new characteristics, which can be utilized or repurposed to fulfill entirely different or new needs. As such, an item produced by this method may become a new item; even a member of a new class of items.

Such is the case with 3D-printing of the 3D-woven structures defined by the existing U.S. Pat. No. 5,263,516 (“the '516 patent”), herein incorporated by reference in its entirety. The 3D-printed items of the present invention are structurally and geometrically similar to the items described in the '516 patent. Because embodiments of the present invention are created using 3D-printing or additive manufacturing, the structures are not created by any kind of “weaving,” but per convention can be described as “weavements.”

The basic element of construction in the embodiments of the '516 patent is a flexible multi-stranded fiber bundle. In contrast, the basic element of construction in embodiments of the present invention is a substantially non-flexible 3D-printed material. Embodiments of the present invention can, given their rigidity, acquire differing configurations, such as high angularity, as opposed to curvaceousness. As may be appreciated, embodiments of the present invention may be manufactured with varying degrees of flexibility. Embodiments of the present invention may also have low angularity and/or a high degree of curvaceousness. Additionally or alternatively, embodiments of the present invention may be substantially hollow, substantially solid, or both, as may be appreciated by one skilled in the art. These characteristics may be seen in the exemplary embodiments described herein.

As compared to the woven structures described in the '516 patent, the overall 3D-printed structures of the present invention remain substantially unchanged, as intended. As such, the descriptions of geometry, structure, interweavement, etc. used in the '516 patent is sufficient to describe the 3D-printed embodiments of the present invention. Constructs in the '516 patent described as the “R-type,” “L-type,” “E-type,” “S-type,” and “C-type,” have been subsequently renamed with reference to embodiments of the present invention as the “IIIR-type,” “IIIL-type,” “OOO-type,” “IOI-type,” and “010-type,” respectively. Additional description is repeated and available at 3D Weavements [online, retrieved on Jul. 21, 2017], retrieved from the internet: <URL:http://www.3dprintedweavements.com>, which is herein incorporated by reference in its entirety.

Despite the similar structure, the relative merits of 3D-printed weavements possess several unique and different characteristics to the woven weavements described in the '516 patent. As such, the 3D-printed weavements of the present invention are only described relative to other 3D-printed weavements.

### SUMMARY OF THE INVENTION

Accordingly, a principal object of the present invention is to provide a three-dimensional woven structure using additive manufacturing and/or 3D printing, which exhibits isotropic mechanical and structural properties by incorporating the highest possible degree of interweavement of its fibers or filaments.

A further object of the present invention is to provide a three-dimensional woven structure using additive manufacturing, which incorporates no weak plane or axis, thereby eliminating the need to orient the material to suit the mechanical and structural strength needs of a given application.

Yet a further object of the present invention is to allow three-dimensional woven structures to be made out of any material or substrate without significant manipulation or time while also minimizing risks that breaks or damage to the materials or substrates diminish the integrity or strength of the fully interwoven object.

Yet a further object of the present invention is to create angular interwoven weavements using an additive manufacturing and/or 3D printing process.

In accomplishing these and other objects, there is provided a three-dimensional woven structure made using additive manufacturing, or 3-D printing, including a plurality of adjacent sets of lateral rods or fibers, a plurality of adjacent sets of transverse rods or fibers and a plurality of adjacent sets of vertical rods or fibers. These lateral, transverse and vertical sets of fibers or rods come together substantially mutually perpendicularly to one another at a plurality of intersection nodes with each intersection node being formed in such a fashion that the lateral, transverse and vertical rods or fibers are fully interwoven with one another. The lateral, transverse and vertical sets of fibers or rods are also seen to form three substantially mutually perpendicular interdistributed sets of planar weave patterns or fabrics. The coming together of the lateral, transverse and vertical sets of fibers in this fashion results in an isotropically interwoven three-dimensional structure, which exhibits the isotropic mechanical and structural characteristics, discussed herein.

Other objects, characteristics and advantages of the present invention will become apparent from a consideration of the following detailed description with reference to the accompanying drawings.

### BRIEF DESCRIPTION OF THE DRAWINGS

FIG. 1a is a perspective view of a cube-like schematic of a fully interwoven curvaceous structure using III weavement, according to one embodiment of the present invention.

FIG. 1b is a perspective view of a cube-like schematic of a fully interwoven angular structure using III weavement, according to one embodiment of the present invention.

FIG. 1c is an exploded perspective view of a cube-like schematic of an interwoven structure, according to one embodiment of the present invention.

FIG. 2a is a perspective view of a cube-like schematic of a fully interwoven curvaceous structure using III weavement, according to one embodiment of the present invention.

FIG. 2b is a perspective view of a cube-like schematic of a fully interwoven angular structure using III weavement, according to one embodiment of the present invention.

FIG. 3a is a perspective view of a cube-like schematic of a fully interwoven curvaceous structure using III weavement, according to one embodiment of the present invention.

FIG. 3b is a perspective view of a cube-like schematic of a fully interwoven angular structure using IOI weavement, according to one embodiment of the present invention.

FIG. 4a is a perspective view of a cube-like schematic of a fully interwoven curvaceous structure using OOO weavement, according to one embodiment of the present invention.

FIG. 4b is a perspective view of a cube-like schematic of a fully interwoven angular structure using OOO weavement, according to one embodiment of the present invention.

FIG. 5a is a perspective view of a cube-like schematic of a fully interwoven curvaceous structure using OIO weavement, according to one embodiment of the present invention.

FIG. 5b is a perspective view of a cube-like schematic of a fully interwoven angular structure using OIO weavement, according to one embodiment of the present invention.

FIG. 6a is a perspective view of a node showing XYZ elements with a solid core, according to one embodiment of the present invention.

FIG. 6b is a perspective view of a node showing XYZ elements with a hollow core, according to one embodiment of the present invention.

FIG. 7 is a perspective view of an interwoven structure, according to one embodiment of the present invention.

FIG. 8 is a perspective view of a cube-like schematic of a fully interwoven structure, according to one embodiment of the present invention.

FIG. 9a is a perspective view of a left-handed node, according to one embodiment of the present invention.

FIG. 9b is a perspective view of a right-handed node, according to one embodiment of the present invention.

### DETAILED DESCRIPTION OF THE PREFERRED EMBODIMENTS

In several embodiments, fully interwoven structures contain four planar substructures, each consisting of four coplanar elements extending in an X-direction and four coplanar elements extending in a Y-direction. In other embodiments, more or less than four planar substructures may be used. In several embodiments, the X- and Y-direction elements may be substantially perpendicular to one another. However, in other embodiments, the elements may not be perpendicular to one another. In some embodiments, the planar substructures are interconnected, stitched, or printed together by substantially parallel elements extending in a Z-direction. For example and example only, where four planar substrates are interconnected, there may be sixteen substantially parallel elements extending in the Z-direction. In some embodiments, the Z-direction elements may be substantially perpendicular to the X- and Y-direction elements. However, in other embodiments, the elements may not be perpendicular to on another.

In some embodiments, the X-direction coplanar elements in planar substructures may be characterized as consisting of adjacent sets of lateral rods, fibers, or bars. Additionally or alternatively, in some embodiments, the Y-direction coplanar elements in planar substructures may be characterized as consisting of adjacent sets of transverse rods, fibers, or bars. Additionally or alternatively, in some embodiments, the Z-direction elements may be characterized as consisting of adjacent sets of vertical rods, fibers, or bars. Thus, a fully-interwoven structure may be partially described as containing adjacent sets of lateral rods, fibers, or bars, adjacent sets of transverse rods, fibers, or bars, and adjacent sets of vertical rods, fibers, or bars. In most embodiments, the lateral, transverse, and vertical sets of rods, fibers, or bars may come together in a substantially mutually perpendicular arrangement, relative to one another. In other embodiments, the rods, fibers, or bars may come together in other arrangements, relative to one another.

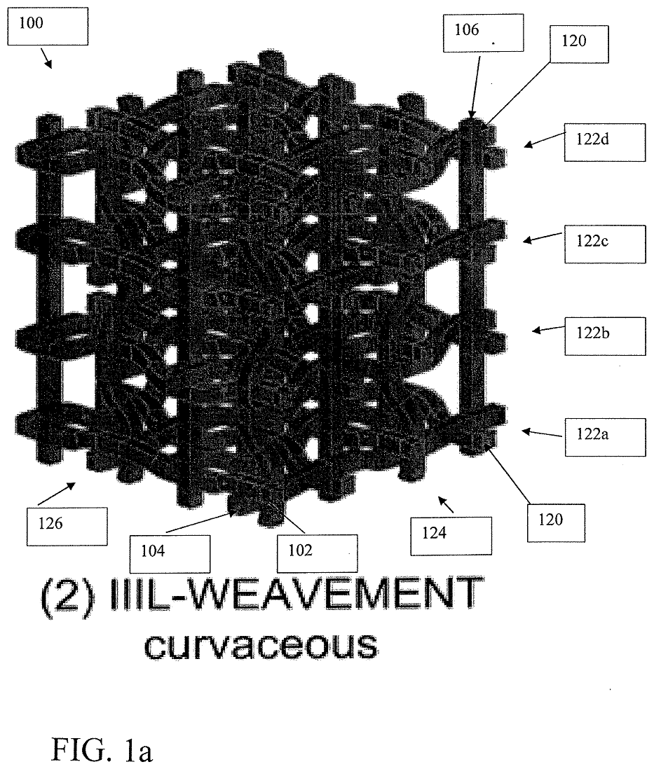

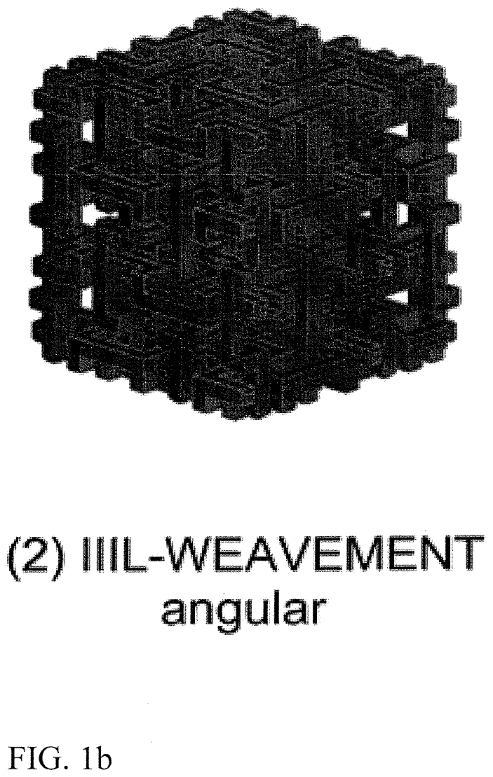

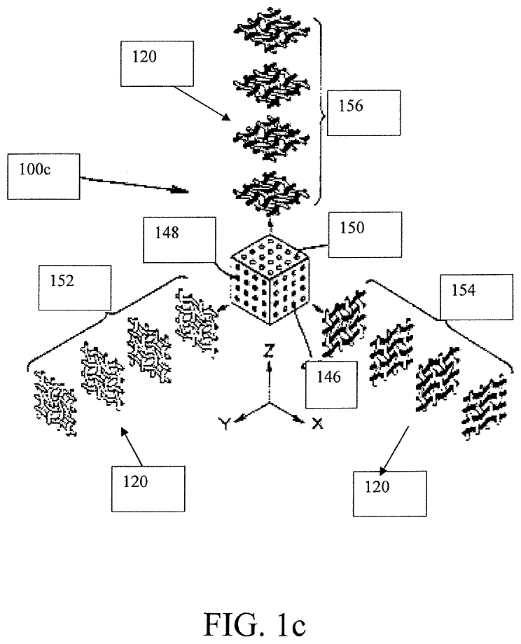

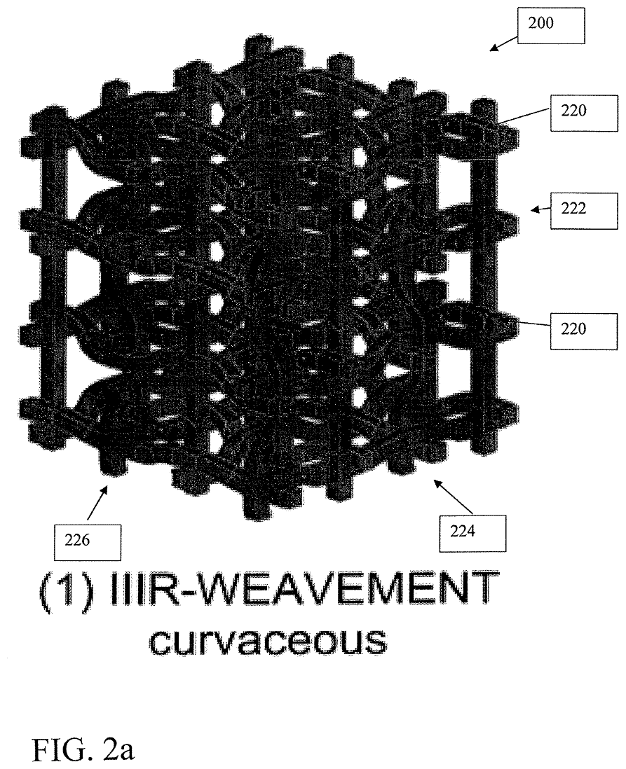

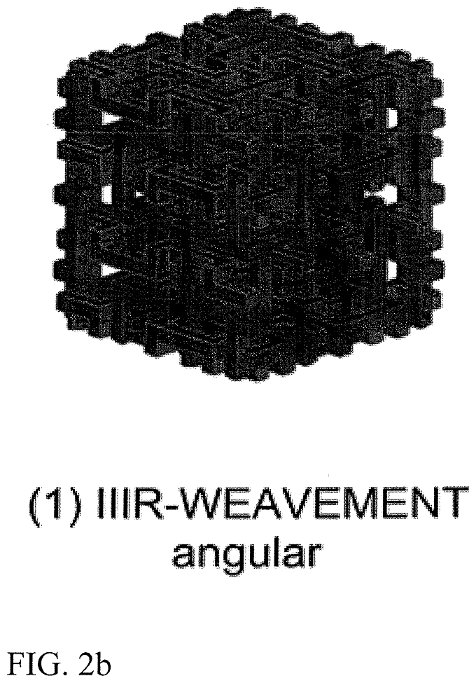

Referring now to FIGS. 1a and 1b, and 1c, a cube-like schematic of a fully-interwoven structure 100 is seen by examining the extent of interweavement exhibited by X-, Y- and Z-direction elements 102, 104, and 106, according to one embodiment of the present invention. The fibers, rods, bars or other material used to make such weavings is herein referred to generally as XYZ elements. A fully-interwoven structure of the type contemplated by the present invention may be viewed as consisting of three sets of substantially mutually perpendicular planar weave patterns with each set having four planar weave patterns. FIG. 1 a shows a curvaceous weavement, according to one embodiment of the present invention. FIG. 2 shows an angular weavement, according to one embodiment of the present invention. As seen in FIG. 1c, each combination of XYZ direction elements creates a substructure or weave pattern 120 of interweavement 100c. A first set of four planar weave patterns 152 with each planar weave pattern consisting of X- and Z-direction elements 146, 150; a second set of four planar weave patterns 154, with each planar weave pattern consisting of Y- and Z-direction elements 148, 150; and a third set of four planar weave patterns 156, with each planar weave pattern consisting of X- and Y-direction elements 146, 148. The three sets of planar weave patterns 152, 154, 156 do not simultaneously exist as independent items in fully-interwoven structure 100. Rather, each planar weave pattern in each set shares one directional element with each planar weave pattern in each of the other two sets. Thus, the sets of planar weave patterns 152, 154, 156 are said to be “interdistributed” with one another.

As seen in FIGS. 1a and 1b, that X- and Y-direction elements 102, 104 of each substructure 122a, 122b, 122c, and 122d form a planar weave pattern. Further, in FIGS. 1a and 1b, it is seen that each Z-direction element 106 extends in structure 122 in such a way as to exhibit the following two characteristics: the Z-direction element alternates the side, near or far, on which it passes corresponding Y-direction elements 104 in adjacent substructures 120, and it simultaneously alternates the side, near or far, on which it passes corresponding X-direction elements 102 in adjacent substructure 120. Thus, Z-direction elements 106 are interwoven with Y-direction elements 104 and are also simultaneously interwoven with X-direction elements 102.

The previously discussed planar weave patterns formed by X- and Y-direction elements 102, 104 may be identified as XY planar weave patterns. Similarly, as can be seen in FIGS. 1a and 1b, Z-direction elements 106 interweave with X- and Y-direction elements, 102, 104 in such a fashion that X- and Z-direction elements 102, 106 create what may be identified as XZ-planar weave patterns and Y- and Z-direction elements 104, 106 create what may be identified as YZ-planar weave patterns.

This condition, the simultaneous formation of XY-, XZ and YZ-planar weave patterns, completely describes the construction of a “fully interwoven structure,” as contemplated by the present invention. It also describes what is meant by the statement that the X-, Y- and Z-direction elements, 102, 104 and 106 are “fully interwoven” with each other.

With continued reference to FIGS. 1a and 1b, the interweavement 100 is depicted where the XYZ elements are arranged in what is herein referred to as an IIIL type interweavement 100. The IIIL type interweavement 100 includes three substantially mutually perpendicular sets of interdistributed planar weave patterns, for example, weave pattern 122 has been broken down into each subset 122a, 122b, 122c, and 122d in FIG. 1a. See also FIG. 1c, showing planar weave patterns 152, 154, 156 of structure 100c. The identical nature of the planar weave patterns in each set is seen by noting that each corresponding intersection in adjacent planar weave patterns exhibit identical “over/under” orientations.

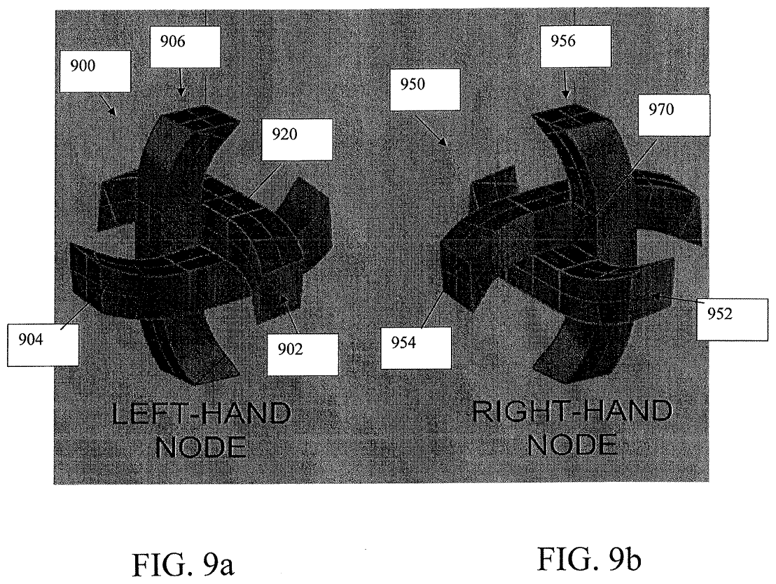

Further, as best seen in FIG. 9a, X-, Y- and Z-direction elements 902, 904, 906 of left-handed weavement 900 come together at three-dimensional intersection nodes 920 that exist throughout left-handed weavement 900. See also nodes 120 in FIGS. 1a and 1b. The left handed nature of left-handed weavement 900 is achieved by interweaving X-, Y- and Z-direction elements 902, 904, 906 in such a way that every intersection node 920 in left-handed weavement 900, if viewed independently and properly oriented, forms an identical “incipient left-handed twist.” Such an incipient left-handed twist is shown most clearly in FIG. 9a, but also seen in FIGS. 1a and 1b, and a node so configured is called a “left-handed node.” Thus, it is seen, with reference to FIGS. 1a and 1b, and 1c, that a left-handed weavement 100 of a fully-interwoven structure of the type contemplated herein has two characteristics: in each of its three sets of planar weave patterns 122, 124, 126 each planar weave pattern is identical; and every intersection node 120 is a left-handed node. It may be noted that the second characteristic, by itself, provides a complete definition of a fully-interwoven left-handed weavement of the type contemplated by the present invention.

It is to be understood that a fully-interwoven structure of the type contemplated by the present invention incorporates the highest possible degree of interweavement of its constituent elements or fibers. Thus, it is further understood that such a fully-interwoven structure exhibits isotropic mechanical and structural properties and therefore does not contain the type of weak axes or planes found in non-fully-interwoven structures. Further, it is seen that in a fully-interwoven structure of the type contemplated herein, the constituent elements are interlocked to the maximal degree. Therefore, the structure can also be created as a self-maintaining, non-impregnated structure, and can additionally be created non-compactly (thus forming a “skeletal structure”).

It is to be further understood that while cube-like structures with each plane having a set of four planar weaves are presented in various embodiments herein, other arrangements are considered within the scope of this disclosure. For example, a fully-interwoven structure may be generally spherical, cuboidal, cylindrical, rectangular or triangular prism, or any other suitable shape. Additionally or alternatively, some embodiments may have more than or less than four sets of planar weaves in each direction.

In fully interwoven three-dimensional structures of the type described hereinabove, the X-, Y- and Z-direction elements may be fully interwoven with one another in a number of ways. As discussed, FIGS. 1a-c represent one type, IIIL interweavement.

In another embodiment, as seen in FIGS. 2a and 2b, an interweavement referred to herein as IIIR type interweavement 200, includes three substantially mutually perpendicular sets of interdistributed planar weave patterns 222, 224, 226 with each set having four identical planar weave patterns a, b, c, d, respectively (similar to those seen in FIG. 1c). The identical nature of the weave patterns in each set is seen by noting that corresponding intersections in adjacent planar weave patterns exhibit identical “over/under” patterns. Reference is hereby made to FIG. 2a which illustrates a set of four planar weave patterns exhibiting identical “over/under” orientations of all corresponding intersections thereby making all four planar weave patterns identical. Hence, it is seen that planar weave patterns a, b, c, and d are identical in each set of planar weave patterns 222, 224, 226.

Further, as best seen in FIG. 9b, X-, Y-, and Z-direction elements 952, 954, 956 come together at three-dimensional intersection “nodes” 970 that exist throughout right-handed weavement 950. The right-handed nature of right-handed weavement 950 is achieved by interweaving X-, Y- and Z-direction elements 952, 954, 956 in such a way that every intersection node 970 in right-handed weavement 950, if viewed independently and properly oriented, forms an identical “incipient right-handed twist.” Such an incipient right-handed twist is shown most clearly in FIG. 9b and a node so configured is called a “right-handed node.”

Thus, it is seen that a right-handed weavement 200, as seen in FIGS. 2a and 2b, of a fully-interwoven structure of the type contemplated herein, has two characteristics: in each of its three sets of planar weave patterns. Each planar weave pattern a, b, c, d is identical; and every intersection node 220 is a right-handed node. It should be noted that the second characteristic, by itself, provides a complete definition of a fully-interwoven right-handed weavement of the type contemplated by the present invention.

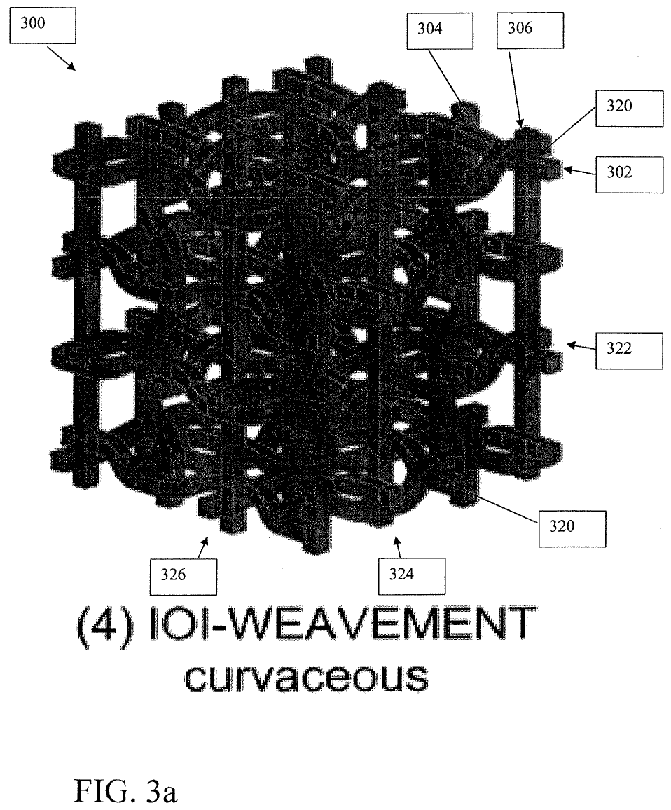

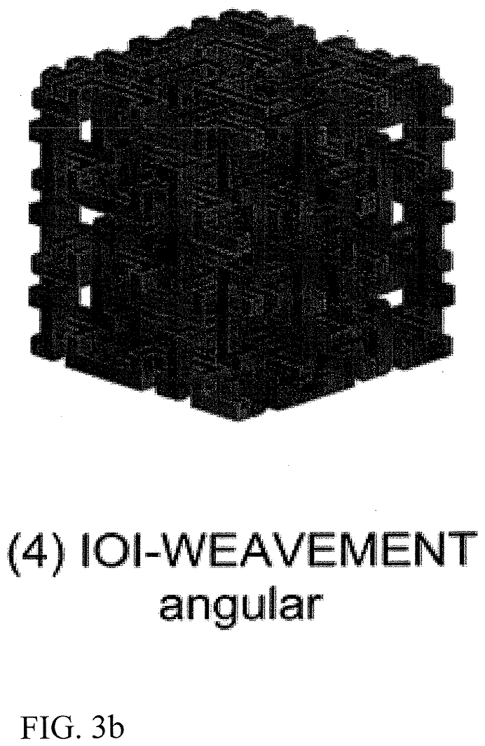

With reference to another embodiment, an interweavement herein referred to as IOI type interweavement may be seen in FIGS. 3a-b. With reference to FIGS. 3a-b, an IOI type interweavement 300, respectively, may include three substantially mutually perpendicular sets of interdistributed planar weave patterns 322, 324, 326. Each set may have four planar weave patterns a, b, c, d. JOT type weavement 300 has two essential characteristics: in each of two of its sets of planar weave patterns all the planar weave patterns are identical; and in its remaining “odd” set of planar weave patterns any two adjacent planar weave patterns are mirror images of one another. (It is therefore a “hybrid” construction.) It may be noted that these two conditions, by themselves, provide a complete definition of a fully-interwoven IOI type weavement of the type contemplated by the present invention.

With reference to FIGS. 3a-3b, the X-, Y- and Z-direction elements 302, 304, 306 of IOI weavement 300 are interwoven in such a way as to form three-dimensional intersection nodes 320 which include equal numbers of left-handed and right-handed nodes. These left-handed and right-handed nodes are distributed among each other in such a fashion that single-layer strata of only right-handed nodes alternate with single-layer strata of only left-handed nodes. These strata are coincident, in a one-with-one fashion, with the planar weave patterns of the “odd” set of planar weave patterns. Due to the described distribution, this weavement may be characterized as non-handed.

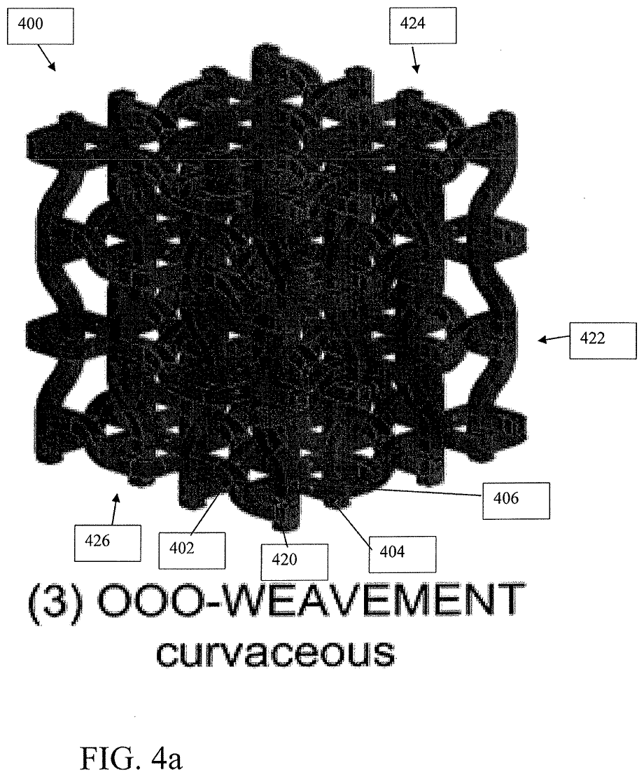

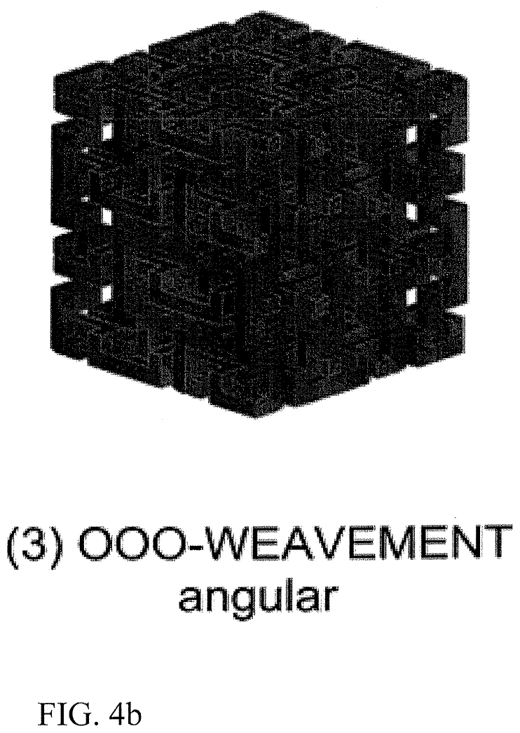

In yet another embodiment, seen in FIGS. 4a and 4b, an interweavement herein referred to as OOO type interweavement 400, includes three substantially mutually perpendicular sets of interdistributed planar weave patterns 422, 424, 426, with each set having four planar weave patterns a, b, c, d. Planar weave patterns a, b, c, d are arranged so that any two adjacent planar weave patterns in any set of planar weave patterns 422, 424, 426 are mirror images of one another. As seen, a set of four planar weave patterns exhibiting reversed “over/under” orientations of corresponding intersections in adjacent planar weave patterns thereby making adjacent planar weave patterns mirror images of one another.

X-, Y-, and Z-direction elements 402, 404, 406 of OOO weavement 400 come together at three-dimensional intersection nodes 420 that exist throughout OOO weavement 400. X-, Y- and Z-direction elements 402, 404, 406 are interwoven in such a way that intersection nodes 420 include equal numbers of left-handed and right-handed nodes. These left-handed and right-handed nodes are distributed among each other in substantially equal manner presenting a “three-dimensional checkerboard pattern.” Due to the described distribution, this weavement may be characterized as “non-handed.”

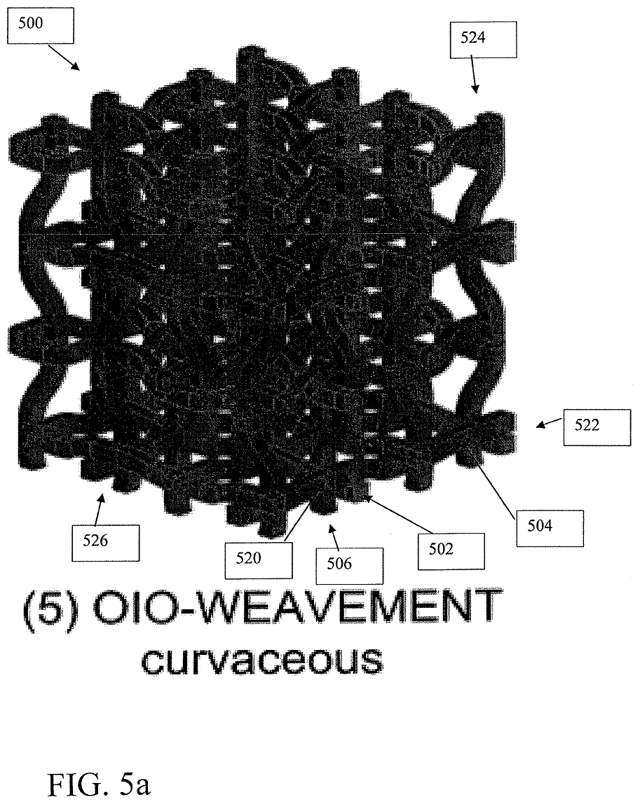

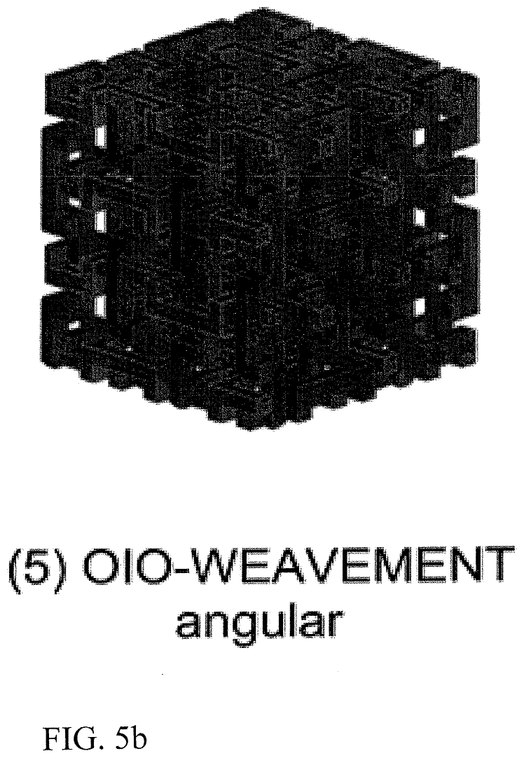

In another embodiment, as seen in FIGS. 5a and 5b, an interweavement herein referred as OIO type interweavement 500 may have three substantially mutually perpendicular sets of interdistributed planar weave patterns 522, 524, 526, with each set having four planar weave patterns a, b, c, d. As seen, column weavement 500 has two essential characteristics: in each of two of its sets of planar weave patterns any two adjacent planar weave patterns are mirror images of one another; and in its remaining “odd” set of planar weave patterns all the planar weave patterns are identical. (It is therefore a “hybrid” construction.) It may be noted that these two conditions, by themselves, provide a complete definition of a fully-interwoven column weavement of the type contemplated by the present invention.

Further, X-, Y- and Z-direction elements 502, 504, 506 are interwoven in such a way as to form three-dimensional intersection nodes 520, which include equal numbers of left-handed and right-handed nodes. In some embodiments, these left-handed and right-handed nodes are distributed among each other in such a fashion that single-file columns of only right-handed nodes are distributed with single-file columns of only left-handed nodes. These two kinds of columns, seen “end on,” are distributed among each other in a checkerboard pattern. These columns are coincident, in a one-with-one fashion, with the stitching elements of the “odd” set of planar weave patterns. Due to the described distribution, this weavement may be characterized as non-handed.

Today, a process known as additive manufacturing or 3-D printing (collectively, referred to herein as “additive manufacturing”) is used to make objects out of a variety of different materials. Additive manufacturing can use inkjet-type depositions, melt or extrusion type depositions, laser-beam melting, sintering of powders (usually metal powders), weld depositions, stereo lithography, or any other additive manufacturing processes known to those in the art. Additive manufacturing can be used to print or construct embodiments of the present invention using a variety of different metals, plastics, resins, glass, or any other suitable material.

Additive manufacturing creates objects by adding or printing very thin slices or layers of material on top of each other to create the object form the bottom-up. In one embodiment, weavement structure 100 may be broken into dozens, hundreds, or thousands of XY-planar slices. As can be appreciated, any object can be broken into any number of planar slices. The XY-planar slices may be added or printed on top of each other to build an object in the Z-direction. The first XY-planar slice may consist of a portion of one or more X-direction elements 102, Y-direction elements 104, and Z-direction elements 106. The second XY-planar slice may add additional material to each of the one or more X-, Y-, and Z-direction elements 102, 104, 106. Each subsequent printing of an XY-planar slice may add additional material to each of the one or more X-, Y-, and Z-direction elements 102, 104, and 106. Each subsequent XY-planar slice may, additionally or alternatively, add a first layer to one or more additional X-, Y-, and Z-direction elements 102, 104, 106. Each subsequent XY-planar slice may, additionally or alternatively, add a final layer to each of the one or more X-, Y-, and Z-direction elements 102, 104, and 106. Each of the rods, fibers, or bars 102, 104, 106 comprising structure 100 can be created or produced at the same time as fully interwoven structure 100 is created. This significantly reduces time, expense, and effort associated with separately manufacturing each rod, fiber or bar as well as manipulating each rod, fiber, or bar to create the woven structure 100.

For example and with reference to FIG. 1a, an additive manufacturing program may take plans for interwoven structure 100 and create several thousand layers to print, one on top of the other, to create a finished interwoven structure 100. For ease of reference and understanding only, it may take 4,000 printed layers to create interwoven structure 100. The first 1,000 layers or so, in general, would consist of slowing building interwoven structure 100 from the base through the first set of the XY-planar weave pattern 122a. After each of the first 1,000 additive layers was printed, each of the four X-direction elements 102 and the four Y-direction elements 104 of XY-planar weave pattern 122a would be constructed. In addition, a portion of each of the sixteen Z-direction elements 106 would be printed in the manner reflected to weave between the various XY direction elements 102, 104. However, because the Z-direction elements 106 run through each of the four planar weave patterns 122a-d, only a quarter of each of the Z-direction elements 106 would be printed after the first 1,000 layers. The next 1,000 layers would result in each of the four X-direction elements 102 and four Y-direction elements 104 of planar weave pattern 122b being constructed as well as another quarter of each of the Z-direction elements. The third 1,000 layers would result in each of the four X-direction elements 102 and four Y-direction elements 104 of planar weave pattern 122c being constructed as well as another quarter of each of the Z-direction elements. Finally, the last 1,000 layers being printed onto each other would result in each of the four X-direction elements 102 and four Y-direction elements 104 of planar weave pattern 122d being constructed as well as the last quarter of each of the Z-direction elements.

As may be appreciated, in some embodiments, there may be some XY-planar slices that do not include an X-direction element 102. As may be appreciated, in some embodiments, there may be some XY-planar slices that do not include a Y-direction element 104. As may be appreciated, in some embodiments, there may be some XY-planar slices that do not include a Z-direction element 106.

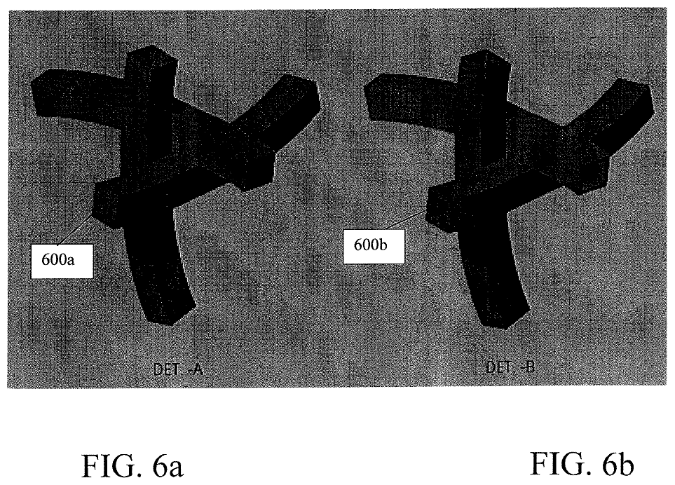

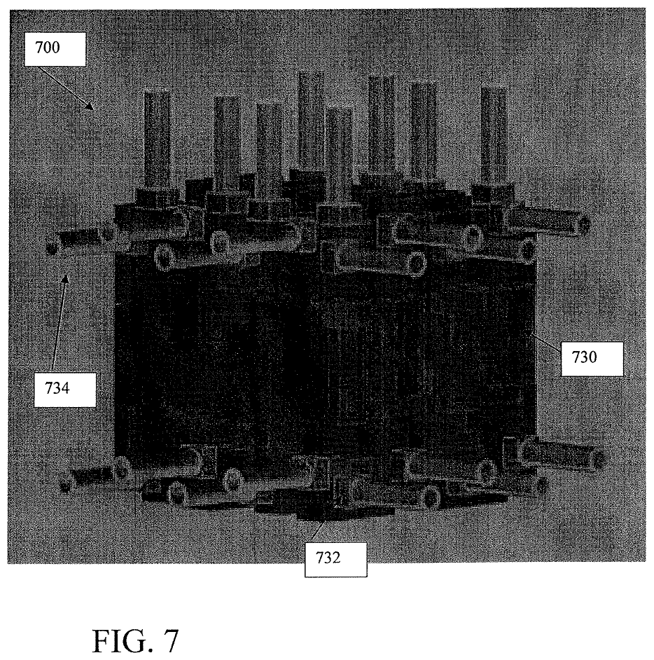

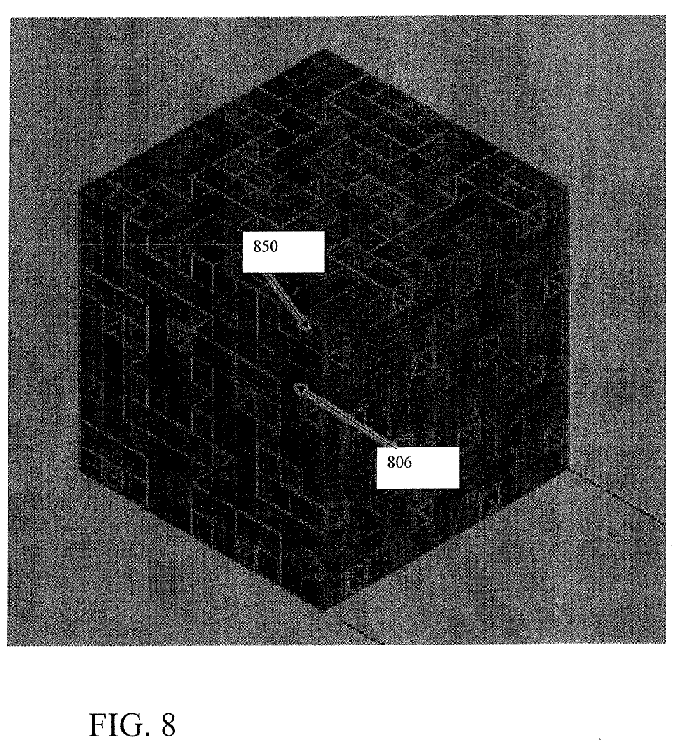

By using additive manufacturing to create the embodiments of the present disclosure, several inventive aspects can be achieved. In various embodiments, one or more XYZ elements may be printed as solid 600a, as seen in FIG. 6a. In some embodiments, one or more XYZ elements may be printed as substantially hollow 600b, as seen in FIG. 6b; see also FIGS. 7-8. As may be appreciated, a hollow structure may help reduce the weight of the object. The hollow structure may, additionally or alternatively, allow for a matter to flow through or exist within the XYZ elements. In one embodiment, one or more of the XYZ elements printed as substantially hollow may further include additional internal structures. For example, as seen in FIG. 8, a mesh or supporting structure 850 may be printed within element 806. In some embodiments, each of the one or more XYZ elements may include one or more supporting structures 850. The supporting structures 850 may be located at an end of an element, at one or more nodes, or at any other desired location.

In various embodiments, the XYZ elements may be comprised of one or more shapes. In one embodiment, each of the one or more XYZ elements can be printed to be substantially circular. In another embodiment, each of the one or more XYZ elements can be, additionally or alternatively, printed as substantially square. In another embodiment, each of the one or more XYZ elements can be, additionally or alternatively, printed as substantially rectangular. As can appreciated, in other embodiments, each of the one or more XYZ elements can be, additionally or alternatively, comprised or printed in any shape, including but not limited to oval shaped, triangle shaped, pentagon shaped, octagon shaped, or any other known arrangement.

Additionally or alternatively, and referencing FIG. 7, one or more of the XYZ elements may be created or printed using two or more different shapes. One or more of the XYZ elements may be created or printed in a substantially rectangular shape 730. At a node, or other desired location, the additive manufacturing process can be used to shift or alter the shape of the XYZ elements being printed in the form of a substantially different shape, for example, square 732. The XYZ elements may, additionally or alternatively, be printed in the form of other substantially different shapes, including but not limited to circular 734. Though not depicted, the circular XYZ elements 734 may continue to be interwoven with other XYZ direction elements. As such, each XYZ elements may consist of a single unitary structure having one or more shapes. Because the various shapes can be printed at the same time and using the same material, there is no need for the independent manufacturing and assembly of each XYZ elements. In addition, because the XYZ elements are unitary and do not require additional assembly, the structural integrity of the individual XYZ elements may increase.

In various embodiments, each of the one or more XYZ elements may be comprised of a similar material. For example, each of the objects may be comprised of a plastic material. In other embodiments, one or more of the XYZ elements may be comprised of a different material. For example, in one embodiment, each of the X- and Y-direction elements may be comprised of aluminum while the Z-direction elements may be comprised of steel. In another embodiment, the X-direction element may be comprised of iron, the Y-direction element comprised of glass, and the Z-direction element comprised of a resin. In yet another embodiment, half of the X-direction elements may be comprised of glass while the other half of the X-direction elements may be comprised of plastic. In still other embodiments, one or more of the plurality of XYZ elements may be comprised of more than one material. For example, an element may be printed to include both metal and glass. As may be appreciated, any number of suitable materials may be used for any of the one or more XYZ elements.

Additionally or alternatively, the various XYZ elements may be printed in the same color. In another embodiment, one or more of the various XYZ elements may be printed using a different color. For example, as seen in FIG. 1a, the X-direction elements 102 may be green, the Y-direction elements 104 may be red, and the Z-direction elements 106 may be blue. As may be appreciated, any suitable color may be used for each of the one or more XYZ elements.

As can be understood, by using additive manufacturing to create a fully-interwoven structure, multiple arrangements and configurations are possible. It is to be understood that the foregoing description and accompanying drawings relate only to preferred embodiments of the present invention. Other embodiments may be utilized without departing from the spirit and scope of the invention. Thus, by way of example and not by limitation, a fully-interwoven structure may be fabricated from interwoven elements comprised of any number of materials. Also, the interwoven elements in a given fully-interwoven structure may include more than one weaving material depending upon the particular application contemplated for the structure. Further, to accommodate particular applications, the fully-interwoven structure may be fabricated in a closely-woven, compact form or a non-closely woven, non-compact form. Accordingly, it is to be further understood that the description and drawings set forth hereinabove are for illustrative purposes only and do not constitute a limitation on the scope of the invention.

I claim:

1. An interwoven structure comprising:
a plurality of adjacent sets of lateral elements comprised of a substantially non-flexible material extruded from a 3-D printer;
a plurality of adjacent sets of transverse elements comprised of a material extruded from a 3-D printer;
a plurality of adjacent sets of vertical elements comprised of a material extruded from a 3-D printer;
said lateral, transverse, and vertical sets of elements coming together substantially mutually perpendicular to one another at a plurality of intersection nodes, to foiin an isotopically interwoven 3-dimensional weavement.

2. The interwoven structure of claim 1 wherein said interwoven structure includes four planar substructures, each having four coplanar elements extending in a Y-direction, four coplanar elements extending in an X-direction and four co-planar elements extending in a Z-direction.

3. The interwoven structure of claim 2 wherein said interwoven structure further includes sixteen substantially parallel elements extending in the Z-direction.

4. The interwoven structure of claim 3 wherein the Z-direction elements are substantially perpendicular to the X- and Y-direction elements.

5. The interwoven structure of claim 1 wherein said isotopically interwoven 3-dimensional weavement is a curvaceous weavement.

6. The interwoven structure of claim 1 wherein said isotopically interwoven 3-dimensional weavement is an angular weavement.

7. The interwoven structure of claim 2 wherein each of said X-, Y- and Z-planar weave patterns shares a directional element with the other planar weave patterns.

8. The interwoven structure of claim 2 each Z-direction element extends in the interwoven structure such that the Z-direction element alternates the side, near or far, on which it passes corresponding Y-direction elements in adjacent substructures 120, and simultaneously alternates the side, near or far, on which it passes corresponding X-direction elements 102 in adjacent substructures.

9. The interwoven structure of claim 8 wherein the Z-direction elements are interwoven with Y-direction elements and are also simultaneously interwoven with X-direction elements.

10. The interwoven structure of claim 7 wherein said X-, Y- and Z-planar weave patterns are interdistributed.

11. The interwoven structure of claim 1 wherein the shape of said structure is selected from spherical, cuboidal, cylindrical, rectangular and triangular prism.
